(19) United States
(12) Patent Application Publication
(10) Pub. No.: US 2016/0319767 A1
(43) Pub. Date: Nov. 3, 2016

(54) CYLINDER LINER OF AN INTERNAL COMBUSTION ENGINE

(71) Applicants: MAHLE METAL LEVE S/A, Jundiaí-Sp (DE); MAHLE INTERNATIONAL GMBH, Stuttgart (DE)

(72) Inventors: Edney Deschauer Rejowski, Jundiai (BR); Jose Carlos Bote Veiga, Mogi Guacu (BR); Ricardo Daltio Riceto, Mogi Guacu (BR)

(21) Appl. No.: 15/103,779

(22) PCT Filed: Dec. 9, 2014
(86) PCT No.: PCT/EP2014/077043

§ 371 Date: Jun. 10, 2016

(30) Foreign Application Priority Data
Dec. 12, 2013 (BR) 10 2013 031969.4

(51) Int. Cl. F02F 1/00; B22D 13/00; B22D 19/00

(52) U.S. Cl. CPC F02F 1/004; B22D 19/0009; B22D 13/00

(57) ABSTRACT

A cylinder liner of an internal combustion engine may include a substantially circular internal wall and an external wall. The external wall may have at least one planar face and at least one substantially circular face disposed concentric with the internal wall. The at least one circular face may have a rough surface defining a distance between peaks and valleys of 0.2 to 2.5 mm.

### CROSS-REFERENCE TO RELATED APPLICATIONS

This application claims priority to Brazilian Patent Application No. 10 2013 031969 4, filed Dec. 12, 2013, and International Patent Application No. PCT/EP2014/077043, filed Dec. 9, 2014, both of which are hereby incorporated by reference in their entirety.

### TECHNICAL FIELD

The present invention relates, in a general manner, to a component of an internal combustion engine and, more specifically, the present invention is related to a cylinder liner of an internal combustion engine.

### BACKGROUND

Internal combustion engines, such as engines which employ the known Otto or Diesel cycles, are widely and commonly utilized in vehicles destined for the movement of both persons and goods, such as passenger, haulage and freight vehicles, including lorries and locomotives. In summary, these engines utilize a fuel having a high hydrocarbon content, such as fossil fuels or those originating from renewable sources, to transform the thermal energy from the burning of the fuel into kinetic energy.

The construction of an internal combustion engine is well known and consists, basically, of a piston moving within the interior of a cylinder associated with a crankshaft. On the upper side of the piston there is provided a combustion chamber comprising components such as spark plugs and/or injection nozzles, at least one intake valve and at least one exhaust valve, mounted in a head associated with the engine block. The components and operation of an internal combustion engine are well known to specialists in the matter, for which reason greater explanation is unnecessary in this descriptive memorandum.

By virtue of the increase in the specific power output of internal combustion engines observed in recent years, as a manner of improving the thermal performance of the assembly and, consequently, reducing the emission of harmful gases to the environment, the blocks of internal combustion engines may be provided with cylinder liners manufactured with a specific material to satisfy particular demands of the application or load characteristics of the engine. This is because the cylinder wall must support a high workload due to the pressure and temperature of combustion together with the friction resulting from the movement of the piston within the interior of the cylinder. In this manner, the cylinder liner is generally realized in material which is wear resistant, such as cast iron, steel, or high strength aluminium alloy, differing from the material of the engine block, generally realized in a lighter ductile material permitting good heat dissipation, such as aluminium or an aluminium alloy having less wear resistance.

With the objective of reducing the size and the weight of the engine block, the cylinder liner may have an eccentricity wherein two diametrically opposed portions have a thickness being less than the remainder of the diameter of the liner, such that the cylinders may be grouped more closely. FIG. 1 illustrates, schematically, three cylinders (30, 30′, 30″) of an internal combustion engine wherein each liner (10) has a lesser thickness in the portions destined to be positioned in a manner lateral to the adjacent cylinder, reducing, consequently, the distance (D) between each cylinder. The distance (D) between each cylinder is commonly called the “bridge”.

In the conventional techniques of manufacture of an engine block in aluminium the liner is normally cast together with the block. In this manner, the liners are located within the mould of the block and the aluminium is poured and subsequently cooled around the liners such as to ensure the mechanical anchorage of the external wall of the liner to the aluminium of the block. HPDC (high pressure die casting), LPDC (low pressure die casting) and gravity casting processes are utilized in these cases.

However, due to the difference in the materials forming the liner and the engine block there is a problem relating to the metal union between the two which may not occur in an appropriate manner, leading to the formation of air voids or pores, resulting in poor anchorage of the liner in the block and the possible rupture thereof during the operation of the engine and/or inefficient heat exchange from the interior of the cylinder to the block, having an impact in terms of deformation of the cylinder wherein the rings slide which, in turn, are not capable of sealing the combustion gases, prejudicing, in this manner, the performance of the engine.

With the objective of circumventing this problem, the document U.S. Pat. No. 3,165,983, of J. B. Thomas, teaches a cylinder liner comprising diverse fins disposed in a star-shaped format, projecting outwards from the liner into the interior of the block. Nevertheless, this solution is inefficient, by virtue of the fact that in addition to the difficulty in obtaining the fins, whether by machining or by plastic deformation, it does not eliminate the problem relating to the formation of air voids or pores between the liner and the block at the moment of casting, resulting in the occurrence of non-uniform heat exchange and leading to distortions in the cylinder during operation of the engine, greatly increasing the wear of components and, furthermore, possibly compromising the seal with the head.

The documents EP 0 919 715, of KS Aluminium Technologie AG, and EP 2 113 320, of Teikoku Piston Ring Co., Ltd., similarly teach the formation of radial fins on the external wall of the liner, which may assume the shape of a parallelogram, of a trapezium, of a T, or of a square, obtained by machining or plastic deformation. However, the obtainment of these geometries is very complex and significantly increases the production time of a liner, in addition to reducing the possibility of the formation of a bridge having a lesser distance between cylinders.

In an alternative solution, the document DE 10 2006 016 524, of Federal Mogul Burscheid GmbH, teaches the coating of the external face of the liner with a layer of silicon-aluminium. Despite the coating, apparently, being an effective solution for the reduction of defects and air voids or pores between the liner and the block, it requires an additional stage of production connected with cleaning and deposition of the coating, which fact increases the related costs, in addition to the difficulty of realizing a uniform deposition.

### SUMMARY

The present invention has the purpose of circumventing these difficulties encountered in the state of the art, among others.

Consequently, a first objective of the present invention is to provide a cylinder liner of an internal combustion engine having good anchorage to the material of the engine block and capable of reducing the spacing between the cylinders, contributing to a more compact and lighter engine block.

An additional objective of the present invention is to provide a cylinder liner of an internal combustion engine preventing the formation of air voids or pores or faults during the casting of the block in the liner.

A further objective of the present invention is to provide a cylinder liner of an internal combustion engine which is easy to obtain, without requiring additional stages of machining to form fins or for the deposition of layers.

For the purpose of satisfying, inter alia, the aforementioned objectives, the present invention teaches a cylinder liner of an internal combustion engine comprising a substantially circular internal wall and an external wall, the external wall having at least one planar face and at least one substantially circular face concentric with the internal wall, wherein the circular face has a rough surface comprising a distance between peaks and valleys of 0.2 to 2.5 mm.

In conformity with the additional and/or alternative embodiments of the invention, the following characteristics, alone or in technically possible combinations, may also be present:
the liner has two planar faces;
the liner has two circular faces substantially concentric with the internal wall and separated by the said two planar faces;
the two cylindrical faces comprise a rough surface comprising a distance between peaks and valleys of 0.2 to 2.5 mm;
the liner is realized by a process of centrifugal casting;
at least one of the planar faces comprises a surface roughness comprised between 0.5 and 4.5 Rz;
the thickness formed between the internal wall and the external wall in the concentric portion is comprised between 1.3 and 5 mm;
the thickness formed between the internal wall and the planar face is less than the thickness formed between the internal wall and the external wall in the concentric portion;
the thickness formed between the internal wall and the planar face is comprised between 0.7 and 2.5 mm;
the length of the planar faces is comprised between 5 and 30% of the total external radial length of the liner.

### BRIEF DESCRIPTION OF THE DRAWINGS

The objectives, the advantages, the effects, and the technical and functional improvements of the present invention shall be better understood from reading the description of a particular embodiment thereof, provided below in relation to the annexed figures. Such figures are schematic and the dimensions and proportions thereof may not correspond to reality, by virtue of the fact that the intention is solely to describe the invention in an exemplified manner and not impose any limitations beyond those defined by the claims below, wherein:

FIG. 1 represents schematically three cylinders of an internal combustion engine comprising respective liners mounted in a block;

FIG. 2 represents schematically a perspective view of the cylinder liner according to one embodiment of the invention; and

FIG. 3 represents schematically a plan view of the cylinder liner of FIG. 2; and

FIG. 4 is a partial cross-sectional view of a liner according to the invention.

### DETAILED DESCRIPTION

The invention is now described in relation to the particular embodiments thereof, making reference moreover to the appended figures. Specific embodiments are described in detail and shown in the figures, with the understanding that they shall be considered to be an exemplification of the principles thereof, and not destined to limit the invention to solely that which is illustrated and described in the present memorandum. It shall be recognized that the different teachings of the embodiments discussed below may be employed separately or in any appropriate combination to produce the same technical effects.

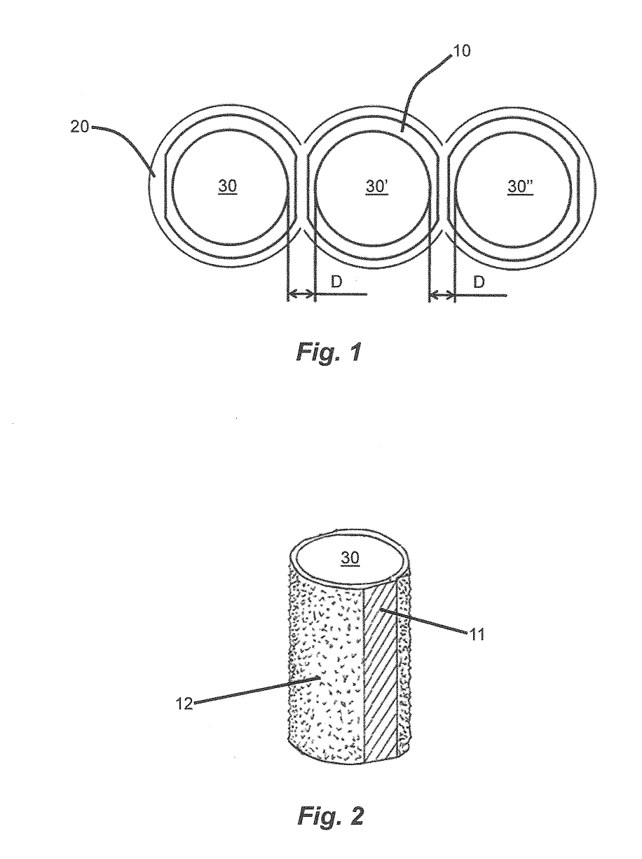

FIG. 1 represents schematically three cylinders (30, 30′, 30″) of an internal combustion engine having, each thereof, a liner (10) surrounded by the material of the engine block (20). Naturally, the representation herein illustrated does not include all the components of an engine block, but solely the cylinders. As aforementioned, by means of current casting techniques, the liners, realized in a material differing from that of the block, are cast together with the block and this may generate problems both of good anchorage of the liner to the block, due to the incompatibility of materials, and of the formation of air voids or pores between the liner and the block, which function as insulating thermal barriers, prejudicing adequate thermal transfer flow and leading to irregular heat transfer from the liner to the block. This problem appears to be especially relevant when two different aluminium alloys are utilized for the liner and the block, being an alloy of high wear resistance for the liner and another of low weight and better heat transfer for the block.

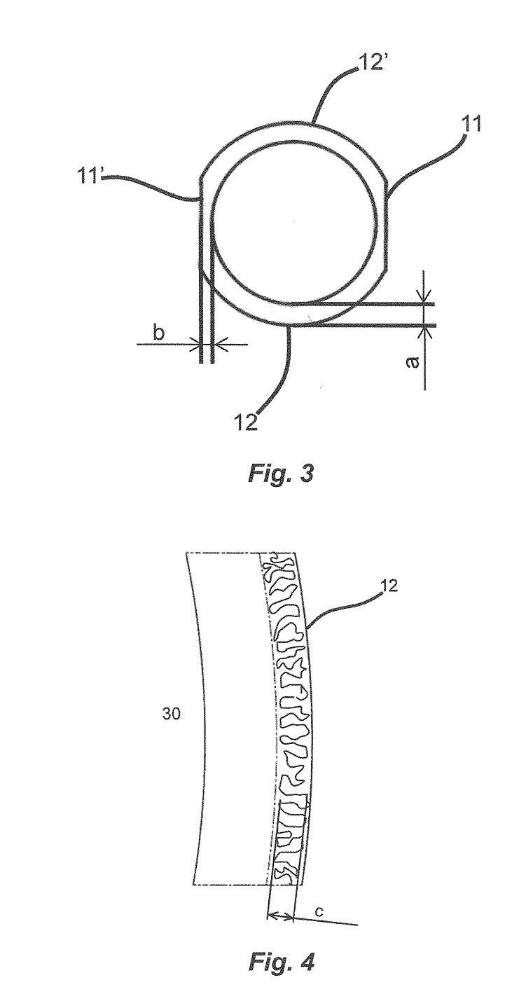

In FIGS. 2 and 3 there is represented a liner according to the invention. It has been found, surprisingly, that providing the circular face of the external wall (12, 12′) of the liner with a rough surface imparts excellent anchorage to the material of the block, cast around the liner, together with low probability of the formation of air voids or pores between the block and the liner, improving in this manner the exchange of heat from the liner to the block. Moreover, due to the greater surface area in contact with the material of the engine block formed by the rough structure, there is also an improvement in transmission of heat to the block. It has been found, furthermore, that the rough surface must have, preferably, a depth comprised between 0.2 and 2.5 mm. By “depth” there shall be understood the measurement taken between the deepest valley and the highest peak in a certain diametral distance present in the rough external structure of the cylinder liner, by virtue of the fact that a rough surface presupposes an irregular plane formed by undulations having differing heights and depths.

FIG. 4 illustrates schematically a partial cross section of the liner of the present invention, showing the rough face (12), wherein is represented the distance between peaks and valleys (c) taken at one point of the liner.

The density and the format of the roughness may vary and are not relevant for the purposes of the obtainment of the technical effects of the present invention, provided that the depth measured along the rough face lies between the values specified above. This roughness may also be distributed along the surface of the face in any manner, that is to say a standard distribution both in amplitude and in spacing is not necessary, always provided that it is not characterized as a deviation of form. Similarly, the roughness may be obtained in a simple manner such as, for example, in the process of casting the liner, particularly employing a process of centrifugal casting, eliminating in this manner subsequent stages of machining or deposition of layers, as found in the state of the art.

Moreover, as there is excellent anchorage of the liner to the block due the presence of the rough face, the subsequent machining of the internal wall of the liner may be realized with higher machining parameters, by virtue of the fact that it supports greater force, both tangential and longitudinal, without presenting a risk of becoming loosened from the block, diminishing, in this manner, manufacturing time.

The external planar face (11, 11′) of the liner, whereat there is provided the eccentricity to form a reduction in distance between adjacent cylinders, may comprise, in a particular manner, a roughness comprised between 0.5 and 4.5 Rz. It has also been found that lower roughness of the planar face, whereat it is destined to form the bridge, permits the better flow of the material of the block during casting. This characteristic prevents the existence of faults or air voids/pores between the liner and the block on this face permitting, in this manner, excellent uniform transmission of heat in the region of the bridge to the block and to the cooling system. The obtainment of the roughness specified may be undertaken both by subsequent machining, following casting of the liner, or by any process of plastic deformation.

The term “substantially circular” used herein shall be interpreted as a shape which is apparently circular, it being known that liners may have slightly ovalled shapes, whether intentionally to compensate for thermal or geometric distortions, or due to the machining itself. In the same manner, the term “substantially concentric” refers to a geometric shape being apparently concentric, it being known that the processes of casting, machining or plastic deformation do not permit the obtainment of absolute concentricity.

The cylinder and the liner may possess any appropriate dimensions, by virtue of the fact that the dimensions of the internal combustion engine itself, and the diameter and the stroke of the piston in the cylinder, may vary depending on the size and application. It has been found that a liner made in conformity with the invention may be realized with relatively small dimensions of thickness, permitting a reduction in the bridge between the cylinders. In a particular manner, the thickness formed between the internal wall of the cylinder and the external wall in the concentric portion (a) may be comprised between 1.3 and 5 mm, and the thickness formed between the internal wall and the planar face (b) is less (b<a) and may be comprised between 0.7 and 2.5 mm.

The material for the realization of the liner and of the block may be known materials, such as high wear resistant aluminium alloys for the liner, and aluminium or aluminium alloys having lower wear resistance for the block.

As may be established from the foregoing description, the present invention circumvents the problems found in the state of the art, by virtue of the fact that the presence of the rough surface permits good anchorage of the liner to the engine block without forming air voids or pores, eliminating stages of machining of the liner for the formation of fins or of the deposition of coating layers. It also permits the formation of a smaller bridge between the cylinders, in this manner permitting that a block be realized having a smaller length and being, consequently, lighter.

In spite of the invention having been described in relation to a particular embodiment thereof, specialists in the art will be able to realize alterations or combinations not contemplated above without, nevertheless, deviating from the teachings herein described, in addition to expansion to other applications not contemplated in the present descriptive memorandum. Consequently, the appended claims shall be interpreted as covering each and every equivalent falling within the principles of the invention.

1. A cylinder liner of an internal combustion engine, comprising:
a substantially circular internal wall and an external wall, the external wall having at least one planar face and at least one substantially circular face disposed concentric with the internal wall, wherein the at least one circular face has a rough surface defining a distance between peaks and valleys of 0.2 to 2.5 mm.

2. The cylinder liner according to claim 1, wherein the external wall has two planar faces.

3. The cylinder liner according to claim 2, wherein the external wall has two circular faces disposed substantially concentric with the internal wall and separated by said two planar faces.

4. The cylinder liner according to claim 1, wherein the external wall has at least two cylindrical faces each defining a rough surface having a distance between peaks and valleys of 0.2 to 2.5 mm.

5. The cylinder liner according to claim 1, wherein the liner is a centrifugally casting liner.

6. The cylinder liner according to claim 1, wherein the at least one planar faces has a surface roughness of between 0.5 and 4.5 Rz.

7. The cylinder liner according to claim 1, wherein a thicknesses defined between the internal wall and the external wall in a concentric portion is between 1.3 and 5 mm.

8. The cylinder liner according to claim 1, wherein a thicknesses defined between the internal wall and the at least one planar face is less than a thickness defined between the internal wall and the external wall in a concentric portion.

9. The cylinder liner according to claim 1, wherein a thickness defined between the internal wall and the at least one planar face is comprised between 0.7 and 2.5 mm.

10. The cylinder liner according to claim 1, wherein the at least one planar face has a length between 5 and 30% of a total external radial length of the liner.

11. The cylinder liner according to claim 2, wherein a thickness defined between the internal wall and said two planar faces is less than a thickness defined between the internal wall and the at least one circular face.

12. The cylinder liner according to claim 11, wherein the thickness defined between the internal wall and said two planar faces is 0.7 to 2.5 mm.

13. The cylinder liner according to claim 11, wherein said two planar faces have a surface roughness of 0.5 to 4.5 Rz.

14. The cylinder liner according to claim 11, wherein the thickness defined between the internal wall and the at least one circular face is 1.3 to 5 mm.

15. The cylinder liner according to claim 3, wherein said two circular faces each define a rough surface having a distance between peaks and valleys of 0.2 to 2.5 mm.

16. The cylinder liner according to claim 15, wherein a thickness defined between the internal wall and each of said two circular faces is 1.3 to 5 mm.

17. The cylinder liner according to claim 15, wherein a thickness defined between the internal wall and each of said two planar faces is less than a thickness defined between the internal wall and each of said two circular faces.

18. A cylinder liner for an internal combustion engine, comprising:
a substantially circular internal wall; and
an external wall, the external wall including at least two planar faces and at least two circular faces, wherein the at least two circular faces are disposed concentric with the internal wall and are separated circumferentially by the at least two planar faces; and
wherein at least one of the at least two circular faces has a rough surface defining a distance between a peak and a valley of 0.2 to 2.5 mm.

19. The cylinder liner according to claim 18, wherein at least one of the at least two planar faces has a surface roughness of between 0.5 and 4.5 Rz.

20. The cylinder liner according to claim 19, wherein a thickness defined between the internal wall and each of the at least two planar faces is less than a thickness defined between the internal wall and each of the at least two circular faces.
